(19) United States
(12) Patent Application Publication
(10) Pub. No.: US 2026/0095329 A1
(43) Pub. Date: Apr. 2, 2026

(54) COMMUNICATION METHOD FOR GLOBAL COMMUNICATION AND RELATED DEVICES

(71) Applicant: Quanzhou global-ptt Co., Ltd., Quanzhou (CN)

(72) Inventor: XIANWU CHEN, Quanzhou (CN)

(73) Assignee: Quanzhou global-ptt Co., Ltd., Quanzhou (CN)

(21) Appl. No.: 18/978,771

(22) Filed: Dec. 12, 2024

(30) Foreign Application Priority Data
Sep. 27, 2024 (CN) 2024113605326

(51) Int. Cl. H04L 9/32

(52) U.S. Cl. CPC H04L 9/3231; H04L 9/3268

(57) ABSTRACT

The method includes receiving data upload information with encrypted to-be-cached data, attribute information, biometric feature information of the user, and access details of a target application. It processes this information to generate a decryption rule, caches data based on a target cache policy, and establishes a secure connection with a download terminal. The method further involves generating a second decryption rule for downloading data, ensuring efficient and secure data transmission between devices. This invention enhances data security and communication efficiency in a global context. The device includes an obtaining module for data and a processing module to execute the method, enhancing efficiency and reliability in global data exchanges.

### CROSS-REFERENCE TO RELATED APPLICATIONS

The application claims priority to Chinese patent application No. 2024113605326, filed on Sep. 27, 2024, the entire contents of which are incorporated herein by reference.

### TECHNICAL FIELD

The present invention relates to the technical field of communication, and in particular, to a communication method for global communication and a related device.

### BACKGROUND

A communication network is a large distributed system for receiving information (signals) and sending the information to a destination. An individual uses various devices to receive video, audio, and text messages (delayed or real-time). For example, typically, the individual may receive messages at several positions through several devices. There is generally a telephone in a home office and a vehicle of the individual. The individual may also carry a mobile phone, a pager, a walkie-talkie, and a personal data assistant (for example, PALM PILOT™). In addition, the individual may have one or more email accounts, a fax machine, and another communication device. Since the individual may not access all devices at all times, several communication attempts may be required before the messages arrive at the individual.

In addition, in the past decades, a demand for communication access is sharply increased, and data may face a risk of being intercepted or tampered during transmission. Therefore, a powerful encryption technology is needed to protect data security. Meanwhile, privacy protection of a user is also an important problem and needs to meet data protection regulations of all countries. Global communication may be delayed due to transmission of data between different servers, particularly during high-traffic time periods, which may influence the efficiency of real-time communication.

It should be noted that the information disclosed in the above background is only used to enhance understanding of the background of the present disclosure, and therefore, the information may include information that does not constitute the prior art known to those of ordinary skill in the art.

### SUMMARY

A purpose of the present disclosure is to provide a communication method for global communication and a related device, to overcome problems existing in the prior art at least to a certain extent. Encrypted data is received and biometric feature information is used to generate a decryption rule, decrypted data is processed and stored according to a cache policy, and a secure connection is established with a download terminal. A second decryption rule is generated to decrypt to-be-downloaded data, and a download priority and duration of the data are determined according to a download policy, to ensure that the data is securely and efficiently transmitted between walkie-talkies.

Other features and advantages of the present disclosure will become apparent from the following detailed description, or may be learned in part by the practice of the present disclosure.

According to an aspect of the present application, a communication method for global communication is provided, including: receiving data upload information sent by an upload terminal, where the data upload information includes encrypted to-be-cached data, attribute information of the to-be-cached data, biometric feature information of an upload terminal user, and access information of a target application; processing the biometric feature information of the upload terminal user and the attribute information of the to-be-cached data, to generate a first decryption rule, where the first decryption rule is used to decrypt the to-be-cached data encrypted by the upload terminal user; caching the to-be-cached data in the data upload information based on a target cache policy, to generate cached data of the upload terminal user; connecting to a download terminal based on a preset processing rule; obtaining attribute information, of to-be-downloaded data, sent by the download terminal, the access information of the target application, and biometric feature information of a download terminal user; generating a second decryption rule for the biometric feature information of the download terminal user and the attribute information of the to-be-downloaded data, where the second decryption rule is used to decrypt encrypted to-be-downloaded data sent by a target server; processing the encrypted to-be-downloaded data based on the second decryption rule, to generate decrypted to-be-downloaded data, where the decrypted to-be-downloaded data matches the cached data of the upload terminal user; and processing the decrypted to-be-downloaded data based on a target download policy, to generate download data information.

In an embodiment of the present application, the caching the to-be-cached data in the data upload information based on a target cache policy, to generate cached data of the upload terminal user includes: processing decrypted to-be-cached data, to generate security level information of the to-be-cached data; processing the biometric feature information of the upload terminal user, the attribute information of the to-be-cached data, the security level information of the to-be-cached data, and the access information of the target application, to generate cache priority information of the to-be-cached data and target cache duration of the to-be-cached data; and processing, based on a preset cache policy, the cache priority information of the to-be-cached data, the target cache duration of the to-be-cached data, and to-be-cached data use information of the upload terminal user, to generate a target cache policy.

In an embodiment of the present application, the processing the biometric feature information of the upload terminal user, the attribute information of the to-be-cached data, the security level information of the to-be-cached data, and the access information of the target application, to generate cache priority information of the to-be-cached data and target cache duration of the to-be-cached data includes: processing the attribute information of the to-be-cached data and identity information of the upload terminal user, to generate the cache priority information of the to-be-cached data; processing the security level information of the to-be-cached data based on the cache priority information of the to-be-cached data, to generate initial cache duration of the to-be-cached data; and processing the initial cache duration of the to-be-cached data based on the access information of the target application, to generate the target cache duration of the to-be-cached data.

In an embodiment of the present application, the connecting to a download terminal based on a preset processing rule includes: obtaining digital certificate information sent by the download terminal, unique identifier information of the download terminal, a random number of the download terminal, key-share information of the download terminal, data processing level information of the download terminal, and security level information of the download terminal; obtaining a random number of the target server and key-share information of the target server; generating a premaster key based on the key-share information of the download terminal and the key-share information of the target server; generating a temporary session key based on the random number of the download terminal, the random number of the target server, and the premaster key; processing the digital certificate information and the unique identifier information of the download terminal based on a preset pairing rule, to generate a processing result; if the processing result is that the target server is allowed to be in pairing connection with the download terminal, obtaining configuration information, where the configuration information includes a domain name certificate and another target server parameter that are required for completing a connection establishment process with the download terminal; encrypting the configuration information based on the temporary session key, to generate encrypted configuration information; processing the data processing level information of the download terminal and the security level information of the download terminal, to generate a connection priority of the download terminal; and sending the encrypted configuration information to the download terminal based on the connection priority of the download terminal to complete the connection establishment process.

In an embodiment of the present application, the processing the decrypted to-be-downloaded data based on a target download policy, to generate download data information includes: processing the decrypted to-be-downloaded data, to generate security level information of the download terminal of the to-be-downloaded data; processing identity information of the download terminal user, the attribute information of the to-be-downloaded data, the security level information of the download terminal of the to-be-downloaded data, and the access information of the target application, to generate download priority information of the to-be-downloaded data and target download duration of the to-be-downloaded data, where the identity information of the download terminal user is generated based on the biometric feature information of the download terminal user; and processing, based on a preset download policy, the download priority information of the to-be-downloaded data, the target download duration of the to-be-downloaded data, and to-be-downloaded data use information of the download terminal user, to generate the target download policy.

In an embodiment of the present application, the processing identity information of the download terminal user, the attribute information of the to-be-downloaded data, the security level information of the download terminal of the to-be-downloaded data, and the access information of the target application, to generate download priority information of the to-be-downloaded data and target download duration of the to-be-downloaded data includes: processing the attribute information of the to-be-downloaded data and the identity information of the download terminal user, to generate the download priority information of the to-be-downloaded data; processing the security level information of the download terminal of the to-be-downloaded data based on the download priority information of the to-be-downloaded data, to generate initial download duration of the to-be-downloaded data; and processing the initial download duration of the to-be-downloaded data based on the access information of the target application, to generate the target download duration of the to-be-downloaded data.

In an embodiment of the present application, the processing, based on a preset download policy, the download priority information of the to-be-downloaded data, the target download duration of the to-be-downloaded data, and to-be-downloaded data use information of the download terminal user, to generate the target download policy includes: obtaining real-time data download processing information of the target server and other downloaded data information; processing the to-be-downloaded data use information based on the real-time data download processing information of the target server, to generate download importance information of the to-be-downloaded data; processing the other downloaded data information based on the download importance information of the to-be-downloaded data, to generate download data adjustment information, where the download data adjustment information is used to perform data deletion processing on the to-be-downloaded data or the other downloaded data information; and processing the download priority information of the to-be-downloaded data and the target download duration of the to-be-downloaded data based on the download data adjustment information, to generate download information of the to-be-downloaded data, where the download information of the to-be-downloaded data is used to represent final download duration and a download occasion that are of the to-be-downloaded data.

According to another aspect of the present application, a communication apparatus for global communication is provided, including: an obtaining module, configured to: receive data upload information sent by an upload terminal, where the data upload information includes encrypted to-be-cached data, attribute information of the to-be-cached data, biometric feature information of an upload terminal user, and access information of a target application; and obtain attribute information, of to-be-downloaded data, sent by a download terminal, the access information of the target application, and biometric feature information of a download terminal user; and a processing module, configured to: process the biometric feature information of the upload terminal user and the attribute information of the to-be-cached data, to generate a first decryption rule, where the first decryption rule is used to decrypt the to-be-cached data encrypted by the upload terminal user; cache the to-be-cached data in the data upload information based on a target cache policy, to generate cached data of the upload terminal user; connect to the download terminal based on a preset processing rule; generate a second decryption rule for the biometric feature information of the download terminal user and the attribute information of the to-be-downloaded data, where the second decryption rule is used to decrypt encrypted to-be-downloaded data sent by a target server; process the encrypted to-be-downloaded data based on the second decryption rule, to generate decrypted to-be-downloaded data, where the decrypted to-be-downloaded data matches the cached data of the upload terminal user; and process the decrypted to-be-downloaded data based on a target download policy, to generate download data information.

According to still another aspect of the present application, an electronic device is provided, including: a first processor; and a memory, configured to store an executable instruction of the first processor, where the first processor is configured to execute the above communication method for global communication by executing the executable instruction.

According to yet another aspect of the present application, a computer-readable storage medium is provided, having a computer program stored thereon, where the computer program, when executed by a second processor, implements the above communication method for global communication.

According to yet another aspect of the present application, a computer program product is provided, including a computer program, where the computer program, when executed by a third processor, implements the above communication method for global communication.

According to a communication method for global communication and a related device that are provided in the present application, a system receives data upload information sent by an upload terminal walkie-talkie, and the information includes encrypted data, a related user, and data attribute information. Then, biometric feature information of an upload terminal user is used to generate a first decryption rule, to decrypt the data. Decrypted data is processed according to a target cache policy, to generate security level information, a cache priority, and target cache duration, and is stored as cached data.

In a data download stage, the system establishes a secure connection with a download terminal walkie-talkie, and a temporary session key is generated through exchange key information. Then, biometric feature information of a download terminal user is used to generate a second decryption rule, to decrypt to-be-downloaded data. Decrypted data matches the cached data, to ensure data consistency. To optimize data transmission, the system generates, based on a preset download policy, download data information, including a download priority and target download duration. This ensures that the data is downloaded efficiently according to importance of the data and a user demand.

In the entire process, security is a factor that is considered primarily. The system protects security of the data transmission by using key exchange and encryption technologies. Meanwhile, the system can adapt to different network conditions and user demands by dynamically adjusting cache and download policies, to improve performance of data communication. In addition, the system further monitors a data communication process and records a critical operation log, to facilitate audit and troubleshooting. These measures jointly ensure security, reliability, and efficiency of data communication between walkie-talkies.

It should be understood that the above general description and the following detailed description are only exemplary and explanatory, and cannot limit the present disclosure.

### BRIEF DESCRIPTION OF THE DRAWINGS

The accompanying drawings herein are incorporated into the specification and constitute a part of the specification, show the embodiments consistent with the present disclosure, and are used for explaining the principle of the present disclosure together with the specification. Apparently, the accompanying drawings in the following description are only some embodiments of the present disclosure, and those of ordinary skill in the art may further derive other accompanying drawings according to these accompanying drawings without creative labor.

FIG. 1 is a flowchart of a communication method for global communication according to an embodiment of the present application;

FIG. 2 is a schematic structural diagram of a communication apparatus for global communication according to an embodiment of the present application;

FIG. 3 is a schematic structural diagram of an electronic device according to an embodiment of the present application;

FIG. 4 is a schematic diagram of a storage medium according to an embodiment of the present application; and

FIG. 5 is a schematic structural diagram of an upload terminal and a download terminal according to an embodiment of the present application.

### DETAILED DESCRIPTION OF THE EMBODIMENTS

The preferred embodiments of the present invention are described below with reference to the accompanying drawings. It should be understood that, the preferred embodiments described herein are merely used to describe and explain the present invention but not to limit the present invention.

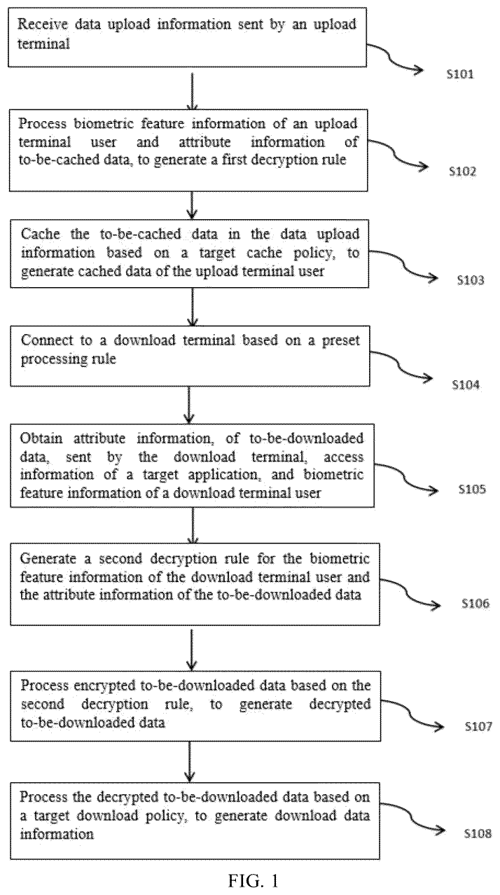

The following describes the communication method for global communication according to an exemplary implementation of the present application with reference to FIG. 1. It should be noted that, the following application scenarios are merely shown for ease of understanding the spirit and principle of the present application, and the implementations of the present application are not limited in this aspect. On the contrary, the implementations of the present application may be applied to any applicable scenarios.

It should be noted that, an upload terminal, a download terminal, and a target server may establish a communication manner through a physical port and the like. One or more download terminals and upload terminals may be deployed in a network system architecture, a same download terminal may be connected to a plurality of target servers, and a same target server may also be communicatively connected to a plurality of download terminals.

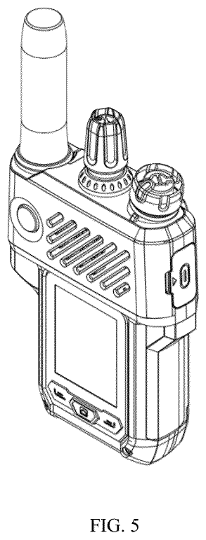

The upload terminal, the download terminal, and the target server are not hardware products determined for the entire network system architecture. The same hardware, such as a computer, a target server, a walkie-talkie with a communication function, a mobile device, and the like, may be used as the download terminal and the download terminal in one case, and the upload terminal and the download terminal may be of a structure shown in FIG. 5.

In an implementation, the present application further provides a communication method for global communication and a related device. Schematically, FIG. 1 is a schematic flowchart of a communication method for global communication according to an implementation of the present application. As shown in FIG. 1, the method is applied to a target server, including:

S101: receiving data upload information sent by an upload terminal.

In an implementation, the upload terminal may be devices such as a walkie-talkie, a smartphone, a desktop, and a tablet computer that can access a network. A user sends the data upload information to the target server through the upload terminal, and the data upload information includes encrypted to-be-cached data, attribute information of the to-be-cached data, biometric feature information of a target user, and access information of a target application, where the access information of the target application is used to represent whether the target user has a right to upload a corresponding resource in the target application, as well as a time period allowed for uploading, and a size of an upload resource. The resource includes but is not limited to real-time voice data and text data.

S102: processing biometric feature information of an upload terminal user and the attribute information of the to-be-cached data, to generate a first decryption rule.

In an implementation, biometric feature information of a download terminal user is processed, to generate identity attribute information of the download terminal user, where the identity attribute information of the download terminal user includes identity information of the download terminal user and to-be-cached data use information of the download terminal user; a preset encryption and decryption mapping table, where the preset encryption and decryption mapping table includes data encryption and decryption information preset by a plurality of users, and data encryption and decryption information set by different users is not unique; identity attribute information of the upload terminal user is processed based on the preset encryption and decryption mapping table, to generate a first decryption rule, where the first decryption rule includes a plurality of encryption and decryption rules set by the upload terminal user for different types of to-be-cached data; and the first decryption rule is processed based on the attribute information of the to-be-cached data, to generate target data encryption and decryption information, where the first decryption rule is used to decrypt the to-be-cached data encrypted by the upload terminal user.

Specifically, the biometric feature information of the download terminal user is collected through a biological recognition technology (for example, fingerprint and facial recognition, and iris scan), and the collected biometric feature information is combined with other identity information (for example, a user name, and an account ID) of the user, to generate identity attribute information of the download terminal user. The identity attribute information should further include a use description of data by the user, for example, whether the data is used for individual learning, work processing, entertainment, or the like.

The preset encryption and decryption mapping table is obtained from secure storage. The table includes encryption and decryption information preset by the user, for example, an encryption algorithm, a key, and an encryption mode. Since different users may have different security demands and privacy preferences, data encryption and decryption information set by each user is unique. The preset encryption and decryption mapping table is used to generate the first decryption rule according to the identity attribute information of the upload terminal user, where the first decryption rule includes the encryption and decryption rules set by the user for different types of to-be-cached data.

The first decryption rule is further processed in combination with the attribute information (for example, a type, sensitivity, an access right requirement, and the like of the data) of the to-be-cached data, to generate final target data encryption and decryption information according to a processing result. These pieces of information will be directly used in encryption and decryption processes of the data. Data of the upload terminal user is encrypted according to the target data encryption and decryption information, to ensure security of the data in transmission and storage processes. When the download terminal user requests the data, a corresponding decryption rule is used to decrypt the data, so that the user may access and use the data. Logs of all encryption and decryption operations are recorded, which include operation time, an operator identity, an operation type, and the like, to facilitate security audit and monitoring, thereby ensuring that all operations meet a data protection regulation and a security policy of a company, and the encryption and decryption mapping table is checked and updated regularly, to cope with a new security threat and a change in a user demand.

S103: caching the to-be-cached data in the data upload information based on a target cache policy, to generate cached data of the upload terminal user.

In an implementation, decrypted to-be-cached data is processed, to generate security level information of the to-be-cached data; the biometric feature information of the upload terminal user, the attribute information of the to-be-cached data, the security level information of the to-be-cached data, and the access information of the target application are processed, to generate cache priority information of the to-be-cached data and target cache duration of the to-be-cached data; and the cache priority information of the to-be-cached data, the target cache duration of the to-be-cached data, and to-be-cached data use information of the upload terminal user are processed based on a preset cache policy, to generate a target cache policy.

Specifically, security review is performed on the decrypted data, to determine sensitivity and importance of the data, and the security level information of the to-be-cached data is generated according to content, a source, and a use manner of the data. A cache priority of the data is evaluated in combination with the biometric feature information of the upload terminal user, the attribute information of the to-be-cached data, a security level of the data, and the access information of the target application. The cache priority may be based on factors such as an access frequency of the data, demand urgency degree of the user, and a size and a type of the data.

Optimal duration of the data stored in a cache is determined according to an attribute and a security level of the to-be-cached data. Cache duration may be influenced by factors such as a data updating frequency, a user access mode, and a limitation of a storage resource. The cache priority information, the target cache duration, and the to-be-cached data use information of the upload terminal user are processed in combination with the preset cache policy. The preset cache policy may include cache space allocation, a data replacement algorithm, a cache invalidation policy, and the like.

The to-be-cached data is stored to an appropriate cache position according to the generated target cache policy, to ensure that an implementation of the cache policy does not violate requirements of data security and privacy protection. A use condition and a performance index such as a cache hit rate and response time of the cache data are monitored, and the cache policy is dynamically adjusted according to a monitoring result and user feedback to optimize performance.

Logs of all cache operations are recorded, which include access, updating, deletion, and the like of the cache data, and security audit is performed regularly, to ensure compliance and effectiveness of the cache policy. When necessary, the user is notified about a change in a data cache state of the user, particularly for processing of sensitive data, to ensure that an appropriate security measure is taken to protect the data from unauthorized access or leakage in an entire cache management process. A modern cache management system and tool is used to implement the above cache policy, for example, using cache technologies such as Redis and Memcached. In addition, considering that different users and applications may have different cache demands, the cache policy should be flexible and can adapt to various different use scenarios.

In another implementation, the attribute information of the to-be-cached data and identity information of the upload terminal user are processed, to generate the cache priority information of the to-be-cached data; the security level information of the to-be-cached data is processed based on the cache priority information of the to-be-cached data, to generate initial cache duration of the to-be-cached data; and the initial cache duration of the to-be-cached data is processed based on the access information of the target application, to generate the target cache duration of the to-be-cached data.

Factors such as a data attribute, a user identity, and an application access mode are comprehensively considered, to determine policies of data cache priority and cache duration. Specifically, the attribute information of the to-be-cached data is analyzed, for example, a type, a size, and an access frequency of the data and a dependency degree of the user on the data, and the identity information of the upload terminal user is combined, for example, a role, a right level, a historical access behavior, and the like of the user.

According to the above information, a preset algorithm or rule is used, to generate the cache priority information of the to-be-cached data. For example, a high priority may be given to data that is high in access frequency, large in data volume, or accessed by a critical user. For example, to generate the cache priority information of the to-be-cached data, an algorithm or a rule set may be designed, and these will consider a plurality of attributes of the data and a behavior mode of the user.

A quantity of times the data has been accessed in the past 24 hours: a higher access frequency, a higher priority, a larger data size, and a larger data volume indicate that more resources may be needed for processing, so that the higher priority may be given. The role or the right level of the upload terminal user: the higher priority may be given to the data accessed by the critical user (for example, a VIP user or an administrator). Data type or classification: some types of data (for example, real-time data or high-value content) may be more important than other types of data. The historical access behavior of the user: if the user frequently accesses some data, the higher priority may be given to these data. Data recency: for data that needs to be updated in real time, the higher priority may be needed to ensure data freshness.

It is assumed that a weight is allocated to each factor, and a comprehensive score is calculated according to these factors, to determine the cache priority: the access frequency: a weight is 0.4; the data volume: a weight is 0.2; the user role: a weight is 0.2; the data type: a weight is 0.1; and a historical access mode: a weight is 0.1.

For each term of data, a score is calculated according to the above factors and the is multiplied by a corresponding weight, and weighted scores of all factors are added finally, to obtain a total score of the data. A higher score indicates a higher cache priority.

It is assumed that there are data terms as follows:

Data A: a high access frequency (score: 90), a medium data volume (score: 50), a common user role (score: 30), a general data type (score: 40), a frequent historical access mode (score: 70). Data B: a medium access frequency (score: 60), a small data volume (score: 20), a critical user role (score: 80), a critical data type (score: 90), a non-frequent historical access mode (score: 30).

Total scores of the data A and the data B are calculated:

$$a score of the data A = ( 90 * 0.4 ) + ( 50 * 0.2 ) + ( 30 * 0.2 ) + ( 40 * 0.1 ) + ( 70 * 0.1 ) = 36 + 10 + 6 + 4 + 7 = 63$$

$$a score of the data B = ( 60 * 0.4 ) + ( 20 * 0.2 ) + ( 80 * 0.2 ) + ( 90 * 0.1 ) + ( 30 * 0.1 ) = 24 + 4 + 16 + 9 + 3 = 56$$

According to a calculation result, a cache priority of the data A is higher than that of the data B.

In actual application, this algorithm may be implemented through programming and integrated into a data management system, automatically calculate a cache priority of new-uploaded data, and manage caching of the data according to these priorities. In addition, this algorithm may be adjusted and optimized according to an actual demand and feedback.

The initial cache duration of the to-be-cached data is determined according to the cache priority information of the to-be-cached data, and data with a high cache priority may obtain longer cache duration, to reduce a frequent data access delay and network load. Meanwhile, considering the security level of the data, data with a high security level may need shorter cache duration, to reduce a risk of data leakage.

The access information of the target application such as a performance requirement of an application, the user access mode, and the data updating frequency is analyzed, and the target cache duration of the to-be-cached data is adjusted in combination with the initial cache duration. For example, for an application that requires rapid response, cache duration may need to be shortened to ensure freshness of data; and for an application with non-frequent data updating, cache duration may be prolonged appropriately to improve cache efficiency. The to-be-cached data is stored in a cache system according to the generated target cache duration, and corresponding overdue time is set, to ensure that an implementation of the cache policy does not violate requirements of data security and privacy protection. Performance such as a cache hit rate, response time, and a data access mode of the cache system is monitored, and the cache policy is dynamically adjusted according to a monitoring result and user feedback, to optimize the performance and user experience.

S104: connecting to a download terminal based on a preset processing rule.

In an implementation, digital certificate information sent by the download terminal, unique identifier information of the download terminal, a random number of the download terminal, key-share information of the download terminal, data processing level information of the download terminal, and security level information of the download terminal are obtained; a random number of the target server and key-share information of the target server are obtained; a premaster key is generated based on the key-share information of the download terminal and the key-share information of the target server; and a temporary session key is generated based on the random number of the download terminal, the random number of the target server, and the premaster key.

The digital certificate information and the unique identifier information of the download terminal are processed based on a preset pairing rule, to generate a processing result; if the processing result is that the target server is allowed to be in pairing connection with the download terminal, configuration information is obtained, where the configuration information includes a domain name certificate and another target server parameter that are required for completing a connection establishment process with the download terminal; the configuration information is encrypted based on the temporary session key, to generate encrypted configuration information; the data processing level information of the download terminal and the security level information of the download terminal are processed, to generate a connection priority of the download terminal; and the encrypted configuration information is sent to the download terminal based on the connection priority of the download terminal to complete the connection establishment process.

Specifically, the digital certificate information sent by the download terminal, the unique identifier information, the random number, the key-share information, the data processing level information, and the security level information are collected, to obtain the random number and the key-share information of the target server from the target server.

The premaster key is generated through a key exchange algorithm (for example, ECDH or DH) by using the key-share information of the download terminal and the target server, and the temporary session key is generated in combination with the random number of the download terminal, the random number of the target server, and the premaster key. This key will be used for encryption of this communication session. The digital certificate information and the unique identifier information of the download terminal are processed according to the preset pairing rule, to generate the processing result. If the processing result allows pairing connection, the configuration information, including the domain name certificate and the another target server parameter, is obtained from the target server. The configuration information is encrypted by using the temporary session key, to generate the encrypted configuration information. The connection priority of the download terminal is generated in combination with the data processing level information and the security level information of the download terminal.

The encrypted configuration information is sent to the download terminal according to the connection priority of the download terminal, to complete the connection establishment process. After receiving the encrypted configuration information, the download terminal completes connection establishment with the target server according to the configuration information by using corresponding decryption key decryption information. In the entire process, a communication state and performance are monitored, and logs of all critical operations are recorded, to facilitate security audit and troubleshooting. It is ensured that all transmitted data are performed through a security channel (for example, TLS/SSL), to prevent a man-in-the-middle attack and another security threat, and it is ensured that the entire process meets a related security standard and regulation requirement, for example, PCI DSS, HIPAA, and GDPR.

During this process, a secure trust relationship needs to be established between the download terminal and the target server, and it is required that both the download terminal and the target server have capabilities to perform encryption and decryption operations. Generally, a corresponding security protocol and a corresponding algorithm need to be implemented at two terminals. In actual application, this process may be implemented through a security module of hardware and software, to ensure operation security and efficiency.

In addition, that the data processing level information of the download terminal and the security level information of the download terminal are processed, to generate a connection priority of the download terminal includes:
obtaining real-time load balancing information of the target server and data connection task information within a preset cycle;
processing the target server based on the data connection task information within the preset cycle, to generate preset connection progress information of the target server;
processing the data processing level information of the download terminal and the security level information of the download terminal, to generate target processing progress information, where the target processing progress information includes processing duration and connection duration that are of the download terminal; and processing the preset connection progress information based on the target
processing progress information, to generate the connection priority of the download terminal.

Specifically, the real-time load balancing information, including a CPU usage rate, memory usage, network bandwidth usage, a current active connection number, and the like, of the target server is collected. The data connection task information within the preset cycle is obtained, which may include start time, estimated duration, a data volume, a priority, and the like of a task. The target server is processed based on the data connection task information within the preset cycle, and a completion progress is predicted, to generate the preset connection progress information.

The data processing level information and the security level information of the download terminal are processed, and considering data sensitivity and processing urgency, the target processing progress information is generated according to a processing capability and a security requirement of the download terminal, which may include estimated processing duration and connection duration. The preset connection progress information of the target server is adjusted according to the target processing progress information of the download terminal, to ensure reasonable allocation of server resources. The connection priority of the download terminal is generated in combination with the preset connection progress information of the server and the target processing progress information of the download terminal, and a high priority may be given to those terminals that are short in processing time, high in data sensitivity, or strict in security requirement.

According to the generated connection priority, a connection policy of the download terminal and the target server is adjusted, a connection request with the high priority is processed preferentially, a load of the server and a connection state of the download terminal are continuously monitored, the connection priority and progress arrangement are optimized according to real-time data, and logs of all critical operations are recorded, which include a load change of the server, task scheduling, adjustment of the connection priority, and the like, to facilitate audit and troubleshooting. If a change of the connection priority influences user experience, the user is notified in time, a reason is explained, and estimated waiting time is provided, to ensure efficient use of the server resources, and meet data processing and security demands of different download terminals.

S105: obtaining attribute information, of to-be-downloaded data, sent by the download terminal, the access information of the target application, and the biometric feature information of the download terminal user.

In an implementation, a specific obtaining manner may refer to the manner of S101 and is not described herein again.

S106: generating a second decryption rule for the biometric feature information of the download terminal user and the attribute information of the to-be-downloaded data.

In an implementation, the biometric feature information of the download terminal user is processed, to generate the identity attribute information of the download terminal user, where the identity attribute information of the download terminal user includes the identity information of the download terminal user and to-be-downloaded data use information of the download terminal user; and a preset decryption mapping table is obtained, where the preset decryption mapping table includes preset data decryption information preset by a plurality of users. The identity attribute information of the download terminal user is processed based on the preset decryption mapping table, to generate the second decryption rule, where the second decryption rule includes a plurality of decryption rules set by the download terminal user for different types of to-be-downloaded data; and the second decryption rule is processed based on the attribute information of the to-be-downloaded data, to generate target data decryption information.

Specifically, the biometric feature information of the download terminal user is collected through a biological recognition technology (for example, fingerprint and facial recognition, and iris scan), and the collected biometric feature information is combined with account information of the user, to generate the identity attribute information of the download terminal user. The identity attribute information includes basic information (for example, a user name and a user ID) of the user and the to-be-downloaded data use information (for example, the data will be used for study, individual use, and commercial use) of the user.

The preset decryption mapping table is obtained from secure storage, and this table includes the decryption information preset by the user, for example, a decryption key, a decryption algorithm, and an access right. The second decryption rule is generated according to the preset decryption mapping table and the identity attribute information of the download terminal user. The second decryption rule is a specific decryption rule for different types of to-be-downloaded data, and these rules may include access control of the data, allocation of the decryption key, an execution condition of a decryption operation, and the like.

The attribute information such as a type, sensitivity, a size, a source, and the like of the data of the to-be-downloaded data is analyzed. The target data decryption information is generated based on the second decryption rule and the attribute information of the to-be-downloaded data. The target data decryption information is a specific instruction used for an actual decryption operation, which includes which decryption algorithm to use, which decryption key to input, under which condition to execute decryption, and the like. The encrypted data is decrypted according to the target data decryption information, so that the download terminal user may access and use the data.

An execution process of the decryption operation is monitored, to ensure security and correctness of the decryption operation, and logs of all related operations are recorded, which include time, an operator, an operation result, and the like of the decryption operation, to facilitate security audit and compliance check. If abnormalities such as a decryption failure and a key error are found during a decryption process, a measure is adopted in time for processing, and a related person is notified. After the decryption operation is completed, the download terminal user is notified, and necessary access guidance and support are provided.

In addition, that the biometric feature information of the download terminal user is processed, to generate the identity attribute information of the download terminal user includes: processing the biometric feature information of the download terminal user, to generate initial face image information and the identity information of the download terminal user, where the initial face image information is face information of the download terminal user within a preset time period; processing the initial face image information, to generate an expression feature influence factor of the download terminal user; processing the expression feature influence factor of the download terminal user based on a preset emotion recognition model, to generate target face image information, where the target face image information includes expression change information of the download terminal user; processing the target face image information, to generate emotion information of the download terminal user; and processing the identity information of the download terminal user and the emotion information of the download terminal user, to generate the identity attribute information of the download terminal user.

Specifically, the biometric feature information of the download terminal user is collected by using a biometric recognition device (for example, a camera), particularly a face image; user face image information within the preset time period is extracted from the collected biometric feature information; and the initial face image information is processed, to recognize and extract a factor that may influence expression recognition, for example, a light condition, face obstruction, and expression intensity.

The expression feature influence factor is analyzed by using the preset emotion recognition model (which may be based on a machine learning or deep learning technology), to reduce misrecognition and improve accuracy. The target face image information is generated based on a processing result of the emotion recognition model, which includes the expression change information of the user, for example, a smile, a frown, and surprise, and emotion states such as happiness, sadness, anger, and surprise of the download terminal user is analyzed and recognized from the target face image information.

The identity information (for example, a name, an age, and a gender) and the emotion information of the download terminal user are combined, to generate the identity attribute information of the user, and the generated identity attribute information is used in various application scenarios such as personalized service, user verification, and sentiment analysis. A user feedback mechanism is provided and the user is allowed to verify and adjust the emotion information of the user, to improve system accuracy and user satisfaction. User feedback and new data are used to continuously optimize the emotion recognition model, to improve an accuracy rate and robustness of recognition.

S107: processing encrypted to-be-downloaded data based on the second decryption rule, to generate decrypted to-be-downloaded data.

In an implementation, the encrypted to-be-downloaded data is processed based on the second decryption rule, to generate the decrypted to-be-downloaded data, ensuring data security and integrity. Specifically, the second decryption rule has been generated according to the identity attribute information of the download terminal user and the preset decryption mapping table. These rules include a key, an algorithm, and a possible additional parameter that are used to decrypt the data. A decryption key and a decryption algorithm for specific to-be-downloaded data are determined according to the second decryption rule. This may involve selecting a correct one from a plurality of keys or selecting a specific algorithm according to a data type.

A selected key and a selected algorithm are used to decrypt the encrypted to-be-downloaded data. This process may include decryption steps of symmetrical encryption (for example, AES), asymmetric encryption (for example, RSA), or a hybrid encryption system, and after decryption, data integrity and correctness are verified. This may be verified by checking checksum and a hash value of the data or by using a digital signature.

The decrypted to-be-downloaded data needs to match the cached data of the upload terminal user and may be implemented by comparing a data identifier, the hash value, or another unique attribute. If the decrypted data does not match the cached data, a corresponding measure needs to be adopted, which may include redownloading the data, regenerating the decryption rule, or notifying the user that the data may be changed.

The decrypted data is transmitted to the download terminal user, it is ensured that a secure data transmission protocol such as HTTPS or FTPS is used during transmission, and a detailed log during the decryption process is recorded, which includes time, an operator, an operation result, and the like, to facilitate audit and monitoring. If any abnormality such as a key error, algorithm mismatching, or data damage occurs during the decryption process, there is a need for a set of abnormality processing mechanism to cope with the abnormality. After the decryption process is completed, the download terminal user is notified. If the data matches the cached data, a subsequent operation may be continued; and if the data does not match the cached data, the user needs to be notified to adopt the corresponding measure. The decrypted to-be-downloaded data matches the cached data of the upload terminal user, that is, relevance exists between the decrypted to-be-downloaded data and the cached data, which may be same content or relevant content. It is ensured that the entire decryption process meets the related security standard and regulation requirement, to protect data confidentiality and integrity.

S108: processing the decrypted to-be-downloaded data based on a target download policy, to generate download data information.

In an implementation, the decrypted to-be-downloaded data is processed, to generate security level information of the download terminal of the to-be-downloaded data; the identity information of the download terminal user, the attribute information of the to-be-downloaded data, the security level information of the download terminal of the to-be-downloaded data, and the access information of the target application are processed, to generate download priority information of the to-be-downloaded data and target download duration of the to-be-downloaded data, where the identity information of the download terminal user is generated based on the biometric feature information of the download terminal user; and the download priority information of the to-be-downloaded data, the target download duration of the to-be-downloaded data, and the to-be-downloaded data use information of the download terminal user are processed base on a preset download policy, to generate the target download policy.

Specifically, security evaluation is performed on the decrypted to-be-downloaded data, to generate the security level information of the download terminal. This may include sensitivity and a confidentiality demand of the data and a demand for data integrity. The identity information (generated based on the biometric feature information of the user) of the download terminal user and the attribute information (for example, a size, a type, a source, and the like of a file) of the to-be-downloaded data. The download priority information of the to-be-downloaded data is generated according to the identity information of the download terminal user, the attribute information of the to-be-downloaded data, the security level information of the download terminal, and the access information of the target application, which may involve considering a right level of the user, an urgency degree of the data, and a demand of the application.

The target download duration of the to-be-downloaded data is determined according to a size of the to-be-downloaded data, a network condition, a user preference, and a system resource. The target download policy is generated based on the preset download policy in combination with the download priority information, the target download duration, and a description of data use by the download terminal user. This policy will guide an actual download process of the data. A download task is scheduled and optimized according to the generated target download policy, which may include allocating a network bandwidth, selecting a download time window, determining a priority of a data stream. A download process is monitored, to ensure that the download task is executed according to the policy. If needed, the download policy is adjusted according to real-time feedback, to cope with a change in the network condition and a change in a user demand.

Before downloading is started and after downloading is completed, the user is notified of related information, including estimated download time, an actual download speed, and any factor that may influence the downloading. Details of all download activities are recorded, including download time, a data size, a user identity, a used network resource, and the like, to facilitate audit and troubleshooting. A coping policy is formulated for an abnormality (for example, network interruption and data damage) that may occur during a download process, user feedback and system performance data are collected, and the download policy is continuously optimized, to improve user experience and system efficiency.

In another implementation, the attribute information the of to-be-downloaded data and the identity information of the download terminal user are processed, to generate the download priority information of the to-be-downloaded data; the security level information of the download terminal of the to-be-downloaded data is processed based on the download priority information of the to-be-downloaded data, to generate initial download duration of the to-be-downloaded data; and the initial download duration of the to-be-downloaded data is processed based on the access information of the target application, to generate the target download duration of the to-be-downloaded data.

Specifically, the attribute information of the to-be-downloaded data is analyzed, for example, a size, a type, importance, an urgency degree, and the like of the data, and the identity information of the download terminal user is combined, for example, a right level, a historical download behavior, a user preference, and the like of the user. According to the above information, a preset algorithm or rule is used, to generate the download priority information of the to-be-downloaded data. For example, a high priority may be given to data that is large in data volume, high in urgency degree, or high in user right level.

The initial download duration of the to-be-downloaded data is determined according to the download priority information and the security level information of the download terminal. The security level information may influence the download duration because data with a higher security level may need an additional security check or encryption measure, which may increase the download time. The access information of the target application is considered, for example, demand urgency of the application on the data and estimated access peak time. The initial download duration is adjusted according to the access information of the application, to generate the target download duration of the to-be-downloaded data. For example, if the application needs to access the data within specific time, the download duration may need to be shortened.

The target download policy is generated in combination with the download priority information and the target download duration. This policy will guide scheduling of the download task, to ensure that the data is downloaded according to a set priority and set duration. The download task is scheduled according to the target download policy, and a necessary network resource and a necessary system resource are allocated. The download process is monitored, to ensure that the download task is executed according to the policy, and adjustment is performed when necessary.

Before the download task is started and after the download task is completed, the user is notified of the related information, including the estimated download time, the actual download speed, and any factor that may influence the downloading. Details of all download activities are recorded, including the download time, the data size, the user identity, the used network resource, and the like, to facilitate audit and troubleshooting. The coping policy is formulated for the abnormality (for example, the network interruption and the data damage) that may occur during the download process, the user feedback and the system performance data are collected, and the download policy is continuously optimized, to improve the user experience and the system efficiency.

In another implementation, real-time data download processing information of the target server and other downloaded data information; the to-be-downloaded data use information is processed based on the real-time data download processing information of the target server, to generate download importance information of the to-be-downloaded data; and the other downloaded data information is processed based on the download importance information of the to-be-downloaded data, to generate download data adjustment information, where the download data adjustment information is used to perform data deletion processing on the to-be-downloaded data or the other downloaded data information. The download priority information of the to-be-downloaded data and the target download duration of the to-be-downloaded data are processed based on the download data adjustment information, to generate download information of the to-be-downloaded data, where the download information of the to-be-downloaded data is used to represent final download duration and a download occasion that are of the to-be-downloaded data.

A download priority and duration of the to-be-downloaded data are adjusted according to the real-time data download processing information of the target server and the downloaded data information, and the download information is determined finally. Specifically, the real-time data download processing information of the target server is collected, which includes current network bandwidth usage, a server load, a download task that is being processed, and the like. The other downloaded data information is obtained, which includes a size, a type, a storage position, a use frequency, and the like of downloaded data. The to-be-downloaded data use information is analyzed according to the real-time data download processing information of the target server, to determine download importance of the to-be-downloaded data. Factors such as an urgency degree of the to-be-downloaded data, a user demand, and data timeliness are considered, to generate the download importance information of the to-be-downloaded data.

The download data adjustment information is generated in combination with the download importance information of the to-be-downloaded data and the other downloaded data information. This adjustment information may include deleting less-used or outdated data, to release storage space and network resources. Downloading of important data is ensured preferentially, and the download priority information and the target download duration of the to-be-downloaded data are adjusted according to the download data adjustment information. A download priority of the important data needs to be improved, download duration thereof needs to be shortened, or priority downgrading processing needs to be performed on non-critical data.

Final download information of the to-be-downloaded data is generated in combination with adjusted download priority and duration. The download information will be used to guide an actual download operation, including determining the final download duration and an optimal download occasion of the data. The download task is scheduled and executed according to the final download information, to ensure that the data is downloaded according to the set priority and the set duration. The download process is monitored, to ensure that the download task is executed according to a set policy, and adjustment is performed when necessary. The download policy is optimized according to a monitoring result and user feedback, to improve download efficiency and user satisfaction.

Before the download task is started and after the download task is completed, the user is notified of the related information, including the estimated download time, the actual download speed, and any factor that may influence the downloading. Details of all download activities and data adjustment operations are recorded, to facilitate audit and troubleshooting. The coping policy is formulated for the abnormality (for example, the network interruption and the data damage) that may occur during the download process, the user feedback and the system performance data are collected, and the download policy is continuously optimized, to improve the user experience and the system efficiency. The user demand and the network condition are considered, to implement efficient and reliable data downloading, and the policy is dynamically adjusted to adapt to a network environment and a user demand that are constantly changing.

According to the present application, a target server receives data upload information sent by an upload terminal walkie-talkie, and the information includes encrypted data, a related user, and data attribute information. Then, biometric feature information of an upload terminal user is used to generate a first decryption rule, to decrypt the data. Decrypted data is processed according to a target cache policy, to generate security level information, a cache priority, and target cache duration, and is stored as cached data.

In a data download stage, a system establishes a secure connection with a download terminal walkie-talkie, and a temporary session key is generated through exchange key information. Then, biometric feature information of a download terminal user is used to generate a second decryption rule, to decrypt to-be-downloaded data. Decrypted data matches the cached data, to ensure data consistency. To optimize data transmission, the system generates, based on a preset download policy, download data information, including a download priority and target download duration. This ensures that the data is downloaded efficiently according to importance of the data and a user demand.

In the entire process, security is a factor that is considered primarily. The system protects security of the data transmission by using key exchange and encryption technologies. Meanwhile, the system can adapt to different network conditions and user demands by dynamically adjusting cache and download policies, to improve performance of data communication. In addition, the system further monitors a data communication process and records a critical operation log, to facilitate audit and troubleshooting. These measures jointly ensure security, reliability, and efficiency of data communication between walkie-talkies.

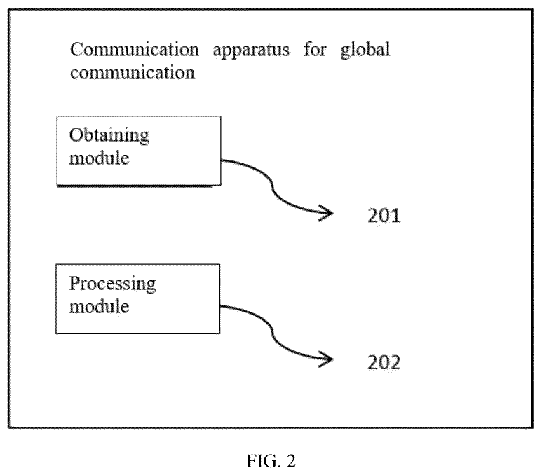

In an implementation, as shown in FIG. 2, the present application further provides a communication apparatus for global communication, including:
an obtaining module 201, configured to: receive data upload information sent by an upload terminal, where the data upload information includes encrypted to-be-cached data, attribute information of the to-be-cached data, biometric feature information of an upload terminal user, and access information of a target application; and obtain attribute information, of to-be-downloaded data, sent by a download terminal, the access information of the target application, and biometric feature information of a download terminal user; and
a processing module 202, configured to: process the biometric feature information of the upload terminal user and the attribute information of the to-be-cached data, to generate a first decryption rule, where the first decryption rule is used to decrypt the to-be-cached data encrypted by the upload terminal user; cache the to-be-cached data in the data upload information based on a target cache policy, to generate cached data of the upload terminal user; connect to the download terminal based on a preset processing rule; generate a second decryption rule for the biometric feature information of the download terminal user and the attribute information of the to-be-downloaded data, where the second decryption rule is used to decrypt encrypted to-be-downloaded data sent by a target server; process the encrypted to-be-downloaded data based on the second decryption rule, to generate decrypted to-be-downloaded data, where the decrypted to-be-downloaded data matches the cached data of the upload terminal user; and process the decrypted to-be-downloaded data based on a target download policy, to generate download data information.

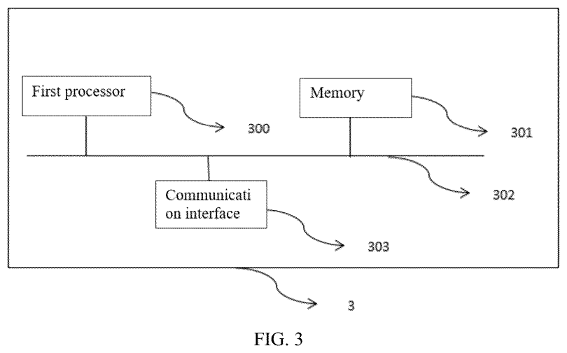

An embodiment of the present application provides an electronic device. As shown in FIG. 3, the electronic device 3 includes a first processor 300, a memory 301, a bus 302, and a communication interface 303, where the first processor 300, the communication interface 303, and the memory 301 are connected through the bus 302; the memory 301 stores a computer program that may be run on the first processor 300; and the first processor 300 executes the communication method for global communication according to any one of the foregoing implementations of the present application when running the computer program.

The memory 301 may include a high-speed random access memory (RAM) or a non-volatile memory, for example, at least one disk memory. A network element of the system is communicatively connected to at least one another network element through at least one communication interface 303 (which may be wired or wireless), and the Internet, a wide area network, a local network, a metropolitan area network, and the like may be used.

The bus 302 may be an ISA bus, a PCI bus, an EISA bus, or the like. The bus may be classified into an address bus, a data bus, a control bus, and the like. The memory 301 is configured to store a program, and after receiving an execution instruction, the first processor 300 executes the program. The communication method for global communication disclosed according to any one of the foregoing implementations in the embodiments of the present application may be applied to the first processor 300 or may be implemented by the first processor 300.

The first processor 300 may be an integrated circuit chip and has a signal processing capability. During implementation, various steps of the above method maybe completed through an integrated logic circuit of hardware or an instruction in a form of software in the first processor 300. The above first processor 300 may be a general-purpose processor, including a central processing unit (CPU), a network processor (NP), and the like, and may also be a digital signal processor (DSP), an application specific integrated circuit (ASIC), a field-programmable gate array (FPGA), or any other programmable logic device, discrete gate or transistor logic device, and discrete hardware assembly. Various methods, steps, and logic block diagrams disclosed in the embodiments of the present application may be implemented or executed. The general-purpose processor may be a microprocessor or the processor may also be any conventional processor or the like. Steps of the method disclosed with reference to the embodiments of the present application may be executed and completed by a hardware decoding processor, or may be executed and completed by using a combination of hardware and software modules in the decoding processor. The software module may be located in a mature storage medium in the art, for example, a random access memory, a flash memory, a read-only memory, a programmable read-only memory, an electrically erasable programmable memory, or a register. The storage medium is located in the memory 301, and the first processor 300 reads information in the memory 301 and completes the steps in the foregoing method in combination with hardware of the processor.

The electronic device provided in the above embodiments of the present application is based on the same inventive concept as that of the communication method for global communication provided in the embodiments of the present application, and has the same beneficial effects as those of a method used, run, or implemented by an application stored in the electronic device.

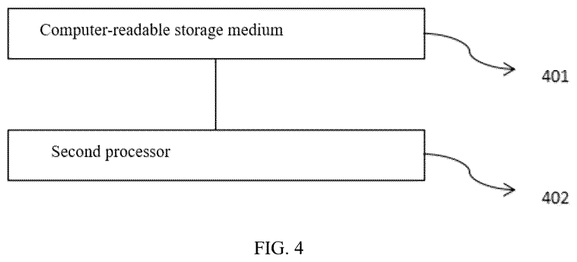

An embodiment of the present application provides a computer-readable storage medium. As shown in FIG. 4, the computer-readable storage medium 401 stores a computer program, and when the computer program is read and run by a second processor 402, the forgoing communication method for global communication is implemented.

The technical solutions of the present application essentially, or the part contributing to the prior art, or all or some of the technical solutions may be implemented in a form of a software product. The computer software product is stored in a storage medium and includes a plurality of instructions for instructing an electronic device (which may be an air conditioner, a refrigeration apparatus, a personal computer, a target server, a network device, or the like) or a processor to perform all or some of the steps of the method described in the embodiments of the present application. The foregoing storage medium includes: various mediums that can store program code, such as a USB flash drive, a removable hard disk, a ROM, a RAM, a magnetic disk, or an optical disc.

The computer-readable storage medium provided in the above embodiments of the present application is based on the same inventive concept as that of the communication method for global communication provided in the embodiments of the present application, and has the same beneficial effects as those of a method used, run, or implemented by an application stored in the computer-readable storage medium.

An embodiment of the present application provides a computer program product, including a computer program, and when the computer program is executed by a third processor, the foregoing method is implemented.

The computer program product provided in the above embodiments of the present application is based on the same inventive concept as that of the communication method for global communication provided in the embodiments of the present application, and has the same beneficial effects as those of a method used, run, or implemented by an application stored in the computer program product.

It should be noted that, in the present application, relational terms such as first and second are used merely to distinguish one entity or operation from another entity or operation and do not necessarily require or imply the existence of any such actual relationship or sequence between these entities or operations. Moreover, the terms “include”, “comprise”, or any other variants thereof are intended to cover non-exclusive inclusion, so that a process, method, item, or device including a series of elements includes not only those elements but also other elements not explicitly listed, or further includes inherent elements of such process, method, article, or device. An element preceded by “includes a . . . ” does not, without more constraints, preclude the existence of additional identical elements in the process, method, article, or device that includes the element.

Various embodiments in the present application are all described in a related manner, for same or similar parts in embodiments, mutual reference may be made. Each embodiment focuses on what is different from other embodiments. In particular, for evaluating communication method for global communication, electronic apparatus, electronic device, and storage medium embodiments, which are substantially similar to the communication method for global communication embodiments, the descriptions are relatively simple, and where relevant, reference can be made to partial descriptions of the communication method for global communication embodiments.

Although the present application is disclosed above, the present application is not limited thereto. Any person skilled in the art may make various changes and modifications without departing from the spirit and scope of the present application, and therefore, the protection scope of the present application shall be subject to the scope defined in the claims.

What is claimed is:

1. A communication method for global communication, applied to a target server, comprising:
receiving data upload information sent by an upload terminal, wherein the data upload information comprises encrypted to-be-cached data, attribute information of the to-be-cached data, biometric feature information of an upload terminal user, and access information of a target application;
processing the biometric feature information of the upload terminal user and the attribute information of the to-be-cached data, to generate a first decryption rule, wherein the first decryption rule is used to decrypt the to-be-cached data encrypted by the upload terminal user;
caching the to-be-cached data in the data upload information based on a target cache policy, to generate cached data of the upload terminal user;
connecting to a download terminal based on a preset processing rule;
obtaining attribute information, of to-be-downloaded data, sent by the download terminal, the access information of the target application, and biometric feature information of a download terminal user;
generating a second decryption rule for the biometric feature information of the download terminal user and the attribute information of the to-be-downloaded data, wherein the second decryption rule is used to decrypt encrypted to-be-downloaded data sent by the target server;
processing the encrypted to-be-downloaded data based on the second decryption rule, to generate decrypted to-be-downloaded data, wherein the decrypted to-be-downloaded data matches the cached data of the upload terminal user; and
processing the decrypted to-be-downloaded data based on a target download policy, to generate download data information.

2. The method according to claim 1, wherein the caching the to-be-cached data in the data upload information based on a target cache policy, to generate cached data of the upload terminal user comprises:
processing decrypted to-be-cached data, to generate security level information of the to-be-cached data;
processing the biometric feature information of the upload terminal user, the attribute information of the to-be-cached data, the security level information of the to-be-cached data, and the access information of the target application, to generate cache priority information of the to-be-cached data and target cache duration of the to-be-cached data; and
processing, based on a preset cache policy, the cache priority information of the to-be-cached data, the target cache duration of the to-be-cached data, and to-be-cached data use information of the upload terminal user, to generate a target cache policy.

3. The method according to claim 2, wherein the processing the biometric feature information of the upload terminal user, the attribute information of the to-be-cached data, the security level information of the to-be-cached data, and the access information of the target application, to generate cache priority information of the to-be-cached data and target cache duration of the to-be-cached data comprises:
processing the attribute information of the to-be-cached data and identity information of the upload terminal user, to generate the cache priority information of the to-be-cached data;
processing the security level information of the to-be-cached data based on the cache priority information of the to-be-cached data, to generate initial cache duration of the to-be-cached data; and
processing the initial cache duration of the to-be-cached data based on the access information of the target application, to generate the target cache duration of the to-be-cached data.

4. The method according to claim 1, wherein the connecting to a download terminal based on a preset processing rule comprises:
obtaining digital certificate information sent by the download terminal, unique identifier information of the download terminal, a random number of the download terminal, key-share information of the download terminal, data processing level information of the download terminal, and security level information of the download terminal;
obtaining a random number of the target server and key-share information of the target server;
generating a premaster key based on the key-share information of the download terminal and the key-share information of the target server;
generating a temporary session key based on the random number of the download terminal, the random number of the target server, and the premaster key;
processing the digital certificate information and the unique identifier information of the download terminal based on a preset pairing rule, to generate a processing result;
if the processing result is that the target server is allowed to be in pairing connection with the download terminal, obtaining configuration information, wherein the configuration information comprises a domain name certificate and another target server parameter that are required for completing a connection establishment process with the download terminal;
encrypting the configuration information based on the temporary session key, to generate encrypted configuration information;
processing the data processing level information of the download terminal and the security level information of the download terminal, to generate a connection priority of the download terminal; and
sending the encrypted configuration information to the download terminal based on the connection priority of the download terminal to complete the connection establishment process.

5. The method according to claim 1, wherein the processing the decrypted to-be-downloaded data based on a target download policy, to generate download data information comprises:
processing the decrypted to-be-downloaded data, to generate security level information of the download terminal of the to-be-downloaded data;
processing identity information of the download terminal user, the attribute information of the to-be-downloaded data, the security level information of the download terminal of the to-be-downloaded data, and the access information of the target application, to generate download priority information of the to-be-downloaded data and target download duration of the to-be-downloaded data, wherein the identity information of the download terminal user is generated based on the biometric feature information of the download terminal user; and
processing, based on a preset download policy, the download priority information of the to-be-downloaded data, the target download duration of the to-be-downloaded data, and to-be-downloaded data use information of the download terminal user, to generate the target download policy.

6. The method according to claim 5, wherein the processing identity information of the download terminal user, the attribute information of the to-be-downloaded data, the security level information of the download terminal of the to-be-downloaded data, and the access information of the target application, to generate download priority information of the to-be-downloaded data and target download duration of the to-be-downloaded data comprises:
processing the attribute information of the to-be-downloaded data and the identity information of the download terminal user, to generate the download priority information of the to-be-downloaded data;
processing the security level information of the download terminal of the to-be-downloaded data based on the download priority information of the to-be-downloaded data, to generate initial download duration of the to-be-downloaded data; and
processing the initial download duration of the to-be-downloaded data based on the access information of the target application, to generate the target download duration of the to-be-downloaded data.

7. The method according to claim 6, wherein the processing, based on a preset download policy, the download priority information of the to-be-downloaded data, the target download duration of the to-be-downloaded data, and to-be-downloaded data use information of the download terminal user, to generate the target download policy comprises:
obtaining real-time data download processing information of the target server and other downloaded data information;
processing the to-be-downloaded data use information based on the real-time data download processing information of the target server, to generate download importance information of the to-be-downloaded data;
processing the other downloaded data information based on the download importance information of the to-be-downloaded data, to generate download data adjustment information, wherein the download data adjustment information is used to perform data deletion processing on the to-be-downloaded data or the other downloaded data information; and
processing the download priority information of the to-be-downloaded data and the target download duration of the to-be-downloaded data based on the download data adjustment information, to generate download information of the to-be-downloaded data, wherein the download information of the to-be-downloaded data is used to represent final download duration and a download occasion that are of the to-be-downloaded data.

8. A communication apparatus for global communication, comprising:
an obtaining module, configured to: receive data upload information sent by an upload terminal, wherein the data upload information comprises encrypted to-be-cached data, attribute information of the to-be-cached data, biometric feature information of an upload terminal user, and access information of a target application; and obtain attribute information, of to-be-downloaded data, sent by a download terminal, the access information of the target application, and biometric feature information of a download terminal user; and
a processing module, configured to: process the biometric feature information of the upload terminal user and the attribute information of the to-be-cached data, to generate a first decryption rule, wherein the first decryption rule is used to decrypt the to-be-cached data encrypted by the upload terminal user; cache the to-be-cached data in the data upload information based on a target cache policy, to generate cached data of the upload terminal user; connect to the download terminal based on a preset processing rule; generate a second decryption rule for the biometric feature information of the download terminal user and the attribute information of the to-be-downloaded data, wherein the second decryption rule is used to decrypt encrypted to-be-downloaded data sent by a target server; process the encrypted to-be-downloaded data based on the second decryption rule, to generate decrypted to-be-downloaded data, wherein the decrypted to-be-downloaded data matches the cached data of the upload terminal user; and process the decrypted to-be-downloaded data based on a target download policy, to generate download data information.

9. An electronic device, comprising:
a first processor; and
a memory, configured to store an executable instruction of the processor, wherein
the processor is configured to execute the communication method for global communication according to claim 1 by executing the executable instruction.

10. A computer-readable storage medium, having a computer program stored thereon, wherein the computer program, when executed by a second processor, implements the communication method for global communication according to claim 1.
